(19) United States
(12) Patent Application Publication
(10) Pub. No.: US 2026/0292893 A1
(43) Pub. Date: Sep. 24, 2026

(54) RANDOM ACCESS METHOD AND APPARATUS, TERMINAL, AND NETWORK-SIDE DEVICE

(71) Applicant: VIVO MOBILE COMMUNICATION CO., LTD., Dongguan (CN)

(72) Inventors: Wei BAO, Dongguan (CN); Hongping ZHANG, Dongguan (CN); Jiamin LIU, Dongguan (CN); Zichao JI, Dongguan (CN); Zhipeng LIN, Dongguan (CN)

(73) Assignee: VIVO MOBILE COMMUNICATION CO., LTD., Dongguan (CN)

(21) Appl. No.: 19/684,729

(22) Filed: May 21, 2026

Related U.S. Application Data
(63) Continuation of application No. PCT/CN2024/137733, filed on Dec. 9, 2024.

(30) Foreign Application Priority Data
Nov. 22, 2023 (CN) 202311567554.5

(51) Int. Cl. H04W 74/0833; H04W 74/00

(52) U.S. Cl. CPC H04W 74/0833; H04W 74/006

(57) ABSTRACT

This application discloses a random access method and apparatus, a terminal, and a network-side device, pertaining to the field of communication technology. The random access method according to an embodiment of this application includes: receiving, by a terminal, a target message sent by a network-side device, where the target message carries scheduling information of transmission occasion RO, wherein the RO is a physical random access channel RO; and determining, by the terminal, a target RO based on the scheduling information of RO, and performing random access based on the target RO; where the target message includes at least one of the following: a paging-related message; or common downlink control information (DCI).

### CROSS-REFERENCE TO RELATED APPLICATIONS

This application is a continuation application of International Application No. PCT/CN2024/137733, filed on Dec. 9, 2024, which claims priority to Chinese Patent Application No. 202311567554.5 filed in China on Nov. 22, 2023, which are incorporated herein by reference in its entirety.

### TECHNICAL FIELD

This application pertains to the field of communication technology, and in particular, relates to a random access method and apparatus, a terminal, and a network-side device.

### BACKGROUND

In the related art, during a random access procedure of a terminal, the following random backoff mechanism exists: If congestion occurs in a random access channel, a network side sends a backoff indication indicating a maximum waiting time T to the terminal; if the terminal does not receive a response for its sent preamble in a random access response reception window or the terminal determines that random access contention resolution fails, the terminal selects a duration Twait with equal probability between 0 and the maximum waiting time T based on the backoff indication. After waiting for the duration Twait, the terminal initiates a next random access attempt.

### SUMMARY

Embodiments of this application provide a random access method and apparatus, a terminal, and a network-side device.

According to a first aspect, a random access method is provided, including:
receiving, by a terminal, a target message sent by a network-side device, where the target message carries scheduling information of transmission occasion (RO), wherein the RO is a physical random access channel RO; and
determining, by the terminal, a target RO based on the scheduling information of RO, and performing random access based on the target RO; where
the target message includes at least one of the following:
a paging-related message; or
common downlink control information (DCI).

According to a second aspect, a random access method is provided, including:
sending, by a network-side device, a target message to a terminal, where the target message carries scheduling information of transmission occasion (RO), wherein the RO is a physical random access channel RO; and the scheduling information of RO is used for random access; where
the target message includes at least one of the following:
a paging-related message; or
common DCI.

According to a third aspect, a random access apparatus is provided, where a terminal includes the random access apparatus, and the apparatus includes:
a first receiving module configured to receive a target message sent by a network-side device, where the target message carries scheduling information of transmission occasion (RO), wherein the RO is a physical random access channel RO; and
an access module configured to determine a target RO based on the scheduling information of RO, and perform random access based on the target RO; where
the target message includes at least one of the following:
a paging-related message; or
common downlink control information (DCI).

According to a fourth aspect, a random access apparatus is provided, where a network-side device includes the random access apparatus, and the apparatus includes:
a sending module configured to send a target message to a terminal, where the target message carries scheduling information of transmission occasion (RO), wherein the RO is a physical random access channel RO; and the scheduling information of RO is used for random access; where
the target message includes at least one of the following:
a paging-related message; or
common DCI.

According to a fifth aspect, a terminal is provided, where the terminal includes a processor and a memory, the memory stores a program or instructions capable of running on the processor, and the program or instructions, when executed by the processor, implement the steps of the method according to the first aspect.

According to a sixth aspect, a network-side device is provided, where the network-side device includes a processor and a memory, the memory stores a program or instructions capable of running on the processor, and the program or instructions, when executed by the processor, implement the steps of the method according to the second aspect.

According to a seventh aspect, a terminal is provided, including a processor and a communication interface, where
the communication interface is configured to: receive a target message sent by a network-side device, where the target message carries scheduling information of transmission occasion (RO), wherein the RO is a physical random access channel RO; and
the processor is configured to: determine a target RO based on the scheduling information of RO, and perform random access based on the target RO; where
the target message includes at least one of the following:
a paging-related message; or
common downlink control information (DCI).

According to an eighth aspect, a network-side device is provided, including a processor and a communication interface, where the communication interface is configured to:
send a target message to a terminal, where the target message carries scheduling information of transmission occasion (RO), wherein the RO is a physical random access channel RO; and the scheduling information of RO is used for random access; where
the target message includes at least one of the following:
a paging-related message; or
common DCI.

According to a ninth aspect, a random access system is provided, including: a terminal and a network-side device, where the terminal may be configured to perform the steps of the method according to the first aspect, and the network-side device may be configured to perform the steps of the method according to the second aspect.

According to a tenth aspect, a readable storage medium is provided, where the readable storage medium stores a program or instructions, and the program or instructions, when executed by a processor, implement the steps of the method according to the first aspect, or implement the steps of the method according to the second aspect.

According to an eleventh aspect, a chip is provided, where the chip includes a processor and a communication interface, the communication interface is coupled with the processor, and the processor is configured to run a program or instructions to implement the method according to the first aspect, or implement the method according to the second aspect.

According to a twelfth aspect, a computer program/program product is provided, where the computer program/program product is stored in a storage medium, and the computer program/program product is executed by at least one processor to implement the steps of the method according to the first aspect, or to implement the steps of the method according to the second aspect.

### BRIEF DESCRIPTION OF DRAWINGS

FIG. 1 is a block diagram of a wireless communication system to which an embodiment of this application is applicable;

FIG. 2 is a first schematic diagram of a random access procedure in the related art;

FIG. 3 is a schematic diagram of a format of an random access response (RAR) message in the related art;

FIG. 4 is a schematic diagram of a format of a medium access control (MAC) RAR unit in the related art;

FIG. 5 is a schematic diagram of a format of a MAC subheader in the related art;

FIG. 6 is a second schematic diagram of a random access procedure in the related art;

FIG. 7 is a first schematic diagram of an association relationship between an RO and an SSB in the related art;

FIG. 8 is a second schematic diagram of an association relationship between an RO and an SSB in the related art;

FIG. 9 is a first flowchart of a random access method according to an embodiment of this application;

FIG. 10 is a second flowchart of a random access method according to an embodiment of this application;

FIG. 11 is a first schematic diagram of a format of a MAC subheader according to an embodiment of this application;

FIG. 12 is a second schematic diagram of a format of a MAC subheader according to an embodiment of this application;

FIG. 13 is a first schematic diagram of an association relationship between an RO and an SSB according to an embodiment of this application;

FIG. 14 is a second schematic diagram of an association relationship between an RO and an SSB according to an embodiment of this application;

FIG. 15 is a third schematic diagram of an association relationship between an RO and an SSB according to an embodiment of this application;

FIG. 16 is a first structural diagram of a random access apparatus according to an embodiment of this application;

FIG. 17 is a second structural diagram of a random access apparatus according to an embodiment of this application;

FIG. 18 is a schematic structural diagram of a communication device according to an embodiment of this application;

FIG. 19 is a schematic structural diagram of a terminal according to an embodiment of this application; and

FIG. 20 is a schematic structural diagram of a network-side device according to an embodiment of this application.

### DETAILED DESCRIPTION

The following describes the technical solutions in the embodiments of this application clearly with reference to the accompanying drawings in the embodiments of this application. Apparently, the described embodiments are some but not all of the embodiments of this application. All other embodiments obtained by persons of ordinary skill in the art based on the embodiments of this application fall within the protection scope of this application.

The terms “first”, “second”, and the like in this application are used to distinguish between similar objects rather than to describe a specific order or sequence. It should be understood that terms used in this way are interchangeable in appropriate circumstances such that the embodiments of this application can be implemented in other orders than the order illustrated or described herein. In addition, objects distinguished by “first” and “second” are generally of a same type, and the quantities of the objects are not limited, for example, there may be one or more first objects. In addition, “or” in the specification and claims represents at least one of connected objects. For example, “A or B” covers three schemes, that is, scheme 1: including A and not including B; scheme 2: including B and not including A; and scheme 3: including both A and B. The term “indication” in the specification and claims of this application may be an explicit indication or an implicit indication. An explicit indication may be understood as a sender explicitly informing a receiver of an operation to be performed or a request result in a sent indication; an implicit indication may be understood as a receiver making a judgment based on an indication sent by a sender and determining an operation to be performed or a request result based on the judgment result.

It should be noted that technologies described in the embodiments of this application are not limited to a long term evolution (LTE)/LTE-Advanced (LTE-A) system, and may also be applied to other wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” are often used interchangeably in the embodiments of this application. The technologies described may be used in the above-mentioned systems and radio technologies as well as other systems and radio technologies. In the following descriptions, a new radio (NR) system is described for illustration purpose, and NR terms are used in most of the following descriptions, although these technologies may also be applied to other applications than an NR system application, for example, the 6th generation (6G) communication system.

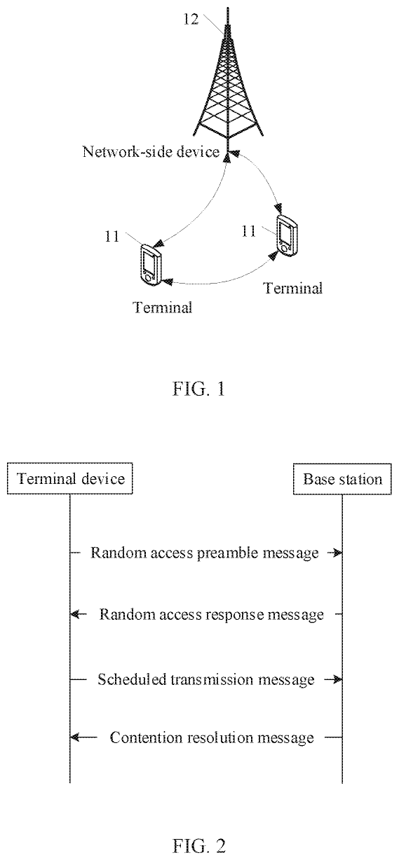

FIG. 1 is a block diagram of a wireless communication system to which an embodiment of this application is applicable. The wireless communication system includes a terminal 11 and a network-side device 12. The terminal 11 may be a terminal-side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), smart household (home devices with wireless communication functions, such as refrigerators, televisions, washing machines, or furniture), a game console, a personal computer (PC), a teller machine, or a self-service machine. The wearable device includes a smartwatch, a smart band, smart earphones, smart glasses, smart jewelry (a smart bracelet, a smart band, a smart ring, a smart necklace, a smart leglet, a smart anklet, and the like), a smart wristband, smart clothing, or the like. It should be noted that the terminal 11 is not limited to a specific type in the embodiments of this application. The network-side device 12 may include an access network device or a core network device. The access network device can also be called a wireless access network device, a radio access network (RAN), a wireless access network function, or a wireless access network unit. The access network device may include a base station, a wireless local area network (WLAN) access point, a wireless fidelity (Wi-Fi) node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or other suitable terms in the field. Provided that the same technical effect is achieved, the base station is not limited to specific technical terms. It should be noted that in the embodiments of this application, only the base station in the NR system is used as an example for description, but the specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (Policy and Charging Rules Function, PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in the embodiments of this application, a core network device in an NR system is used as an example for description, but the specific type of the core network device is not limited.

As described above, in the related art, during a random access procedure of a terminal, the following random backoff mechanism exists: If congestion occurs in a random access channel, a network side sends a backoff indication indicating a maximum waiting time T to the terminal; if the terminal does not receive a response for its sent preamble in a random access response reception window or the terminal determines that random access contention resolution fails, the terminal selects a duration Twait with equal probability between 0 and the maximum waiting time T based on the backoff indication. After waiting for the duration Twait, the terminal initiates a next random access attempt. However, the above random backoff mechanism may cause the terminal to wait for a long time before initiating the next random access attempt.

In the embodiments of this application, a terminal receives a target message sent by a network-side device, where the target message carries scheduling information of RO; and the terminal determines a target RO based on the scheduling information of RO, and performs random access based on the target RO; where the target message includes at least one of the following: a paging-related message; or common downlink control information (DCI). In this way, the network-side device has the scheduling information of RO carried through at least one of a random access response message, a paging-related message, and DCI. Through the scheduling information of RO, more ROs can be dynamically scheduled for the terminal to perform random access, thereby shortening the waiting time for the terminal to initiate a random access attempt.

For ease of understanding, the following describes some contents involved in the embodiments of this application.

### 1. 4-Step Random Access Channel (RACH) Procedure

### 1.1. 4-Step Random Access Procedure

FIG. 2 shows a 4-step random access procedure.

A contention-based random access procedure is mainly divided into four steps.

Msg1: A terminal selects a random access resource and uses the random access resource to send a selected random access signal to a base station.

It should be noted that the terminal selects a time-frequency resource (that is, an RO) and a preamble for sending Msg1 from a random access resource set broadcast by a network side; therefore, there is a possibility of Msg1 collision, that is, multiple terminals select associated ROs to send a same preamble.

After sending Msg1, the terminal calculates, based on a transmission time-frequency position of Msg1, identification information (such as a random access radio network temporary identity (Random Access Radio Network Temporary Identity, RA-RNTI)) for the network side to schedule Msg2. After sending Msg1, the terminal monitors a downlink channel within a preconfigured time window (such as a random access response window (RAR window)) to obtain feedback information Msg2 from the network side.

Msg2: The base station sends a random access response to the terminal. The random access response includes: Msg1 identification information (such as a RAPID); uplink timing advance information (such as a timing advance command); uplink transmission grant information (such as an uplink (UL)) grant); backoff information (such as a backoff indicator); and temporary terminal identification information (such as a temporary cell radio network temporary identifier (C-RNTI)). If the terminal has not received, by the end of the RAR window, a random access preamble identifier (RAPID) corresponding to its sent Msg1, it considers that the RAR reception fails. This includes two cases.
(1) The user equipment (UE, that is, a terminal) does not receive an RAR message within the RAR window.
(2) The UE receives an RAR Message within the RAR window, but the RAR Message does not contain the RAPID corresponding to its sent Msg1.

If the second case occurs and the RAR Message includes backoff information, the UE determines, based on an indication of the backoff information, the time for performing a next RACH attempt. If it is the first case, or it is the second situation and the RAR Message received by the UE does not include backoff information, the UE may perform a next random access attempt at a next available physical random access channel transmission occasion (PRACH transmission Occasion or PRACH Occasion, RO) moment.

Msg3: If the UE successfully receives the RAR, the terminal performs uplink transmission on the UL grant specified by Msg2. The uplink transmission content of the Msg3 varies depending on different random access reasons. For example, for initial access, Msg3 transmits a radio resource control (RRC) connection setup request.

Msg4: Contention resolution message. The terminal can determine whether the random access is successful based on Msg4.

The terminal starts a contention resolution timer when or after sending Msg3. If Msg4 has not been successfully received by the time the contention resolution timer expires, the UE considers that the Msg4 reception fails.

After the Msg4 reception fails, the UE may initiate a next RACH attempt. If the UE has received backoff information during reception of Msg2, the UE determines, based on the backoff information, the time to initiate the next RACH attempt.

1.2. Medium Access Control (MAC) Protocol Data Unit (PDU) (that is, Random Access Response)

FIG. 3 shows a format of an RACH message (Msg) 2 (such as an RAR message) in the 4-step random access procedure.

The RAR message includes two types of subPDUs and padding.

### Type A1:

subPDU containing BI: contains only a 1-byte (byte) subheader which is used to carry RACH backoff information.

### Type A2:

subPDU containing RAPID: can be divided into two types. One is a format containing only a 1-byte subheader, and the other is a format containing a 1-byte subheader and a MAC RAR unit. This type of subPDU is used to carry a response to the detected preamble (preamble).

Padding: consists entirely of padding bits (bit).

The RAR message includes at least one of type A1 subPDU or type A2 subPDU, and may include Padding.

The format of the MAC subheader of the type A1 subPDU is: E/T/R/R/BI; and the format of the subheader of the type A2 subPDU is: E/T/RAPID.

The meanings of the indication fields (or fields) in the MAC subheader of the A1/A2 subPDU are as follows:
E: If the E field (or field) is set to 1, this subPDU is not the last subPDU of the RAR message, that is, there are other subPDUs behind; if the E field is set to 0, this subPDU is the last subPDU, and if there are other remaining bits in the RAR message after this subPDU, the remaining bits are padding. Specifically, the E or Extension field is a flag indicating whether the MAC subPDU including this MAC subheader is the last MAC subPDU in the MAC PDU. The E field is set to 1 to indicate that at least another MAC subPDU follows. The E field is set to 0 to indicate that the MAC subPDU including this MAC subheader is the last MAC subPDU in the MAC PDU (The Extension field is a flag indicating if the MAC subPDU including this MAC subheader is the last MAC subPDU or not in the MAC PDU. The E field is set to 1 to indicate that at least another MAC subPDU follows. The E field is set to 0 to indicate that the MAC subPDU including this MAC subheader is the last MAC subPDU in the MAC PDU).
T: 0 indicates that this subPDU MAC subheader includes a BI field, and 1 indicates that this subPDU MAC subheader includes a RAPID field. Specifically, the T or Type field is a flag indicating whether the MAC subheader contains a random access preamble ID or a backoff indicator. The T field is set to 0 to indicate the presence of a Backoff Indicator field in the subheader (BI). The T field is set to 1 to indicate the presence of a Random Access Preamble ID field in the subheader (RAPID) (The Type field is a flag indicating whether the MAC subheader contains a Random Access Preamble ID or a Backoff Indicator. The T field is set to 0 to indicate the presence of a Backoff Indicator field in the subheader (BI). The T field is set to 1 to indicate the presence of a Random Access Preamble ID field in the subheader (RAPID)).
R: Reserved bit (Reserved bit), set to 0 (set to 0).
BI: The Backoff Indicator (Backoff Indicator) field is used to indicate the overload condition (overload condition) in the cell, with a length of 4 bits. The size of the BI field is 4 bits (The Backoff Indicator field identifies the overload condition in the cell. The size of the BI field is 4 bits).
RAPID: The Random Access Preamble IDentifier (Random Access Preamble Identifier, RAPID) field is used to indicate index (index) information of the random access preamble detected/received by the cell. The size of the RAPID field is 6 bits. If the RAPID in the MAC subheader of a MAC subPDU corresponds to one of the Random Access Preambles configured for SI request, the MAC RAR is not included in the MAC subPDU. (The size of the RAPID field is 6 bits. If the RAPID in the MAC subheader of a MAC subPDU corresponds to one of the Random Access Preambles configured for SI request, MAC RAR is not included in the MAC subPDU).

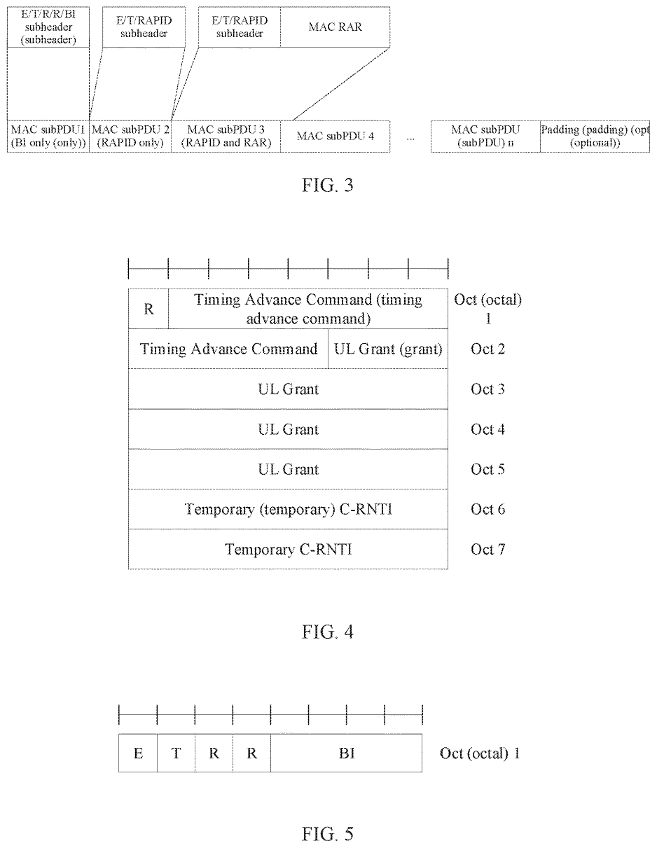

For the MAC subheader containing E/T/RAPID, if it corresponds to MAC RAR, its corresponding MAC RAR unit format is shown in FIG. 4.

In current practical applications, the total length of the MAC RAR unit is constantly 7 bytes.

For the MAC subheader containing E/T/R/R/BI, its subheader format is shown in FIG. 5.

The BI field has a total of 16 values ranging from 0 to 15, with each value of the BI field corresponding to one backoff time length.

### 1.3. Backoff Parameter Values

The values of the Backoff parameter are shown in Table 1.

TABLE 1
Backoff Parameter values

| | Backoff Parameter |
|---|---|
| Index | value (ms) |
| 0 | 5 |
| 1 | 10 |
| 2 | 20 |
| 3 | 30 |
| 4 | 40 |
| 5 | 60 |
| 6 | 80 |
| 7 | 120 |
| 8 | 160 |
| 9 | 240 |
| 10 | 320 |
| 11 | 480 |
| 12 | 960 |
| 13 | 1920 |
| 14 | Reserved |
| 15 | Reserved |

If the UE receives a Random Access Response message within the RAR window, and the message includes a MAC subPDU corresponding to the Backoff Indicator, the UE sets the local variable PREAMBLE_BACKOFF based on the received Backoff Indicator.

If the UE receives a Random Access Response message within the RAR window, and the message does not include a MAC subPDU corresponding to the Backoff Indicator, the UE sets the local variable PREAMBLE_BACKOFF to 0 ms.

If the random access is not successfully completed, the UE randomly selects a backoff value based on a uniform distribution between 0 and PREAMBLE_BACKOFF (ms). After waiting for the selected backoff value, the UE performs the Random Access resource selection procedure again, that is, starts the next RACH attempt.

### 2. 2-Step RACH (2-Step RACH) Procedure

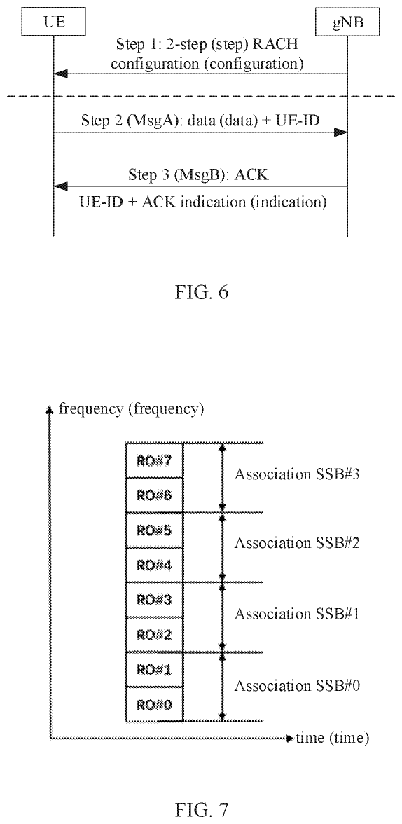

As shown in FIG. 6, the 2-step RACH procedure includes the following steps.
Step (1): A network side configures a UE with configuration information for two-step random access, such as including transmission resource information corresponding to MsgA.
Step (2): The UE triggers the 2-step RACH procedure and sends to the network side the request information (MsgA), for example, via a physical uplink shared channel (PUSCH) and a preamble. When or after sending MsgA, the UE starts a timer msgB-Response Window and monitors MsgB. The duration of the timer msgB-Response Window is preconfigured by the network.
Step (3): The network side sends confirmation information (MsgB) to the UE. If the UE fails to receive MsgB, the UE resends Msg1, or resends MsgA, or sends Msg3, which is specifically determined based on the UE's failure to receive MsgB. The failure to receive MsgB means that no contention resolution identifier (Identifier, ID) corresponding to the MsgA sent by the UE itself is received within the msgB-ResponseWindow window.

### 3. Rules for Synchronization Signal Block (Synchronization Signal Block, SSB) to RO Mapping in 5G NR

The physical random access channel (Physical Random Access Channel, PRACH) resource and SSB-RO configuration parameter are configured in system information block (SIB) 1. In NR, a cell can configure multiple frequency division multiplexed (FDM) physical random access channel transmission occasions (PRACH transmission occasion or PRACH Occasion, RO) at one time-domain position for PRACH transmission. The number of FDM ROs that can be performed at one moment may be: {1,2,4,8}, which is configured and determined by the higher layer parameter Msg1-FDM.

The random access preamble (Preamble) can only be transmitted on the time-domain resource configured by the parameter PRACHConfigurationIndex and the frequency-domain resource configured by the parameter Msg1-FDM. The PRACH frequency-domain resources meet n_{RA}∈{0, 1, . . . , M−1}, where M equals the higher layer parameter Msg1-FDM. During initial access, the PRACH frequency-domain resources n_{RA} are numbered in ascending order starting from the lowest frequency RO resource in the initial active uplink bandwidth part (initial active uplink bandwidth part); otherwise, the PRACH frequency-domain resources n_{RA} are numbered in ascending order starting from the lowest frequency RO resource in the active uplink bandwidth part (active uplink bandwidth part). For example, in FIG. 7, the number of FDM ROs at one moment is 8 (Msg1-FDM=8), and the RO resources are sequentially numbered RO #0 to RO #7 in ascending order of frequency.

In NR, an association relationship exists between ROs and actually sent synchronization signal/physical broadcast channel blocks (SS/PBCH block, SSB). ROs are associated with SSBs in a frequency-first (from low frequency to high frequency) time-second manner. One SSB may be associated with multiple consecutive ROs, or multiple SSBs may be associated with one RO (in this case, different SSBs correspond to different preambles), which is configured by the network through the parameter ssb-perRACH-OccasionAndCB-PreamblesPerSSB. For example, the parameter ssb-perRACH-OccasionAndCB-PreamblesPerSSB is as follows:

```
{
ssb-perRACH-OccasionAndCB-PreamblesPerSSB CHOICE {
  oneEighth ENUMERATED
{n4,n8,n12,n16,n20,n24,n28,n32,n36,n40,n44,n48,n52,n56,n60,n64},
  oneFourth ENUMERATED
{n4,n8,n12,n16,n20,n24,n28,n32,n36,n40,n44,n48,n52,n56,n60,n64},
  oneHalf ENUMERATED
{n4,n8,n12,n16,n20,n24,n28,n32,n36,n40,n44,n48,n52,n56,n60,n64},
  one ENUMERATED
{n4,n8,n12,n16,n20,n24,n28,n32,n36,n40,n44,n48,n52,n56,n60,n64},
  two ENUMERATED {n4,n8,n12,n16,n20,n24,n28,n32},
  four INTEGER (1..16),
  eight INTEGER (1..8),
  sixteen INTEGER (1..4)
  } OPTIONAL, - Need M
  }
```

For example, oneEighth means that one SSB is associated with 8 consecutive ROs, and eight means that 8 SSBs are associated with one RO. {n4, n8, n12, . . . } represents the number of preambles associated with each SSB on one RO. For example, the value n4 means that the number of preambles associated with each SSB on one RO is 4, and n8 means that the number of preambles associated with each SSB on one RO is 8.

After all SSBs have completed one round of association with ROs, an SSB-RO mapping cycle is formed. One SSB to RO association period may include one or more SSB-RO mapping cycles. One SSB to RO association pattern period may include one or more SSB-RO association periods. The SSB to RO mapping is repeated periodically with the association pattern period as the cycle, where the maximum association pattern period is 160 ms.

Usually, the base station can use different beams to transmit different SSBs, where the number of SSBs is configured through the ssb-PositionsInBurst parameter. For FR2, the maximum number of SSBs is 64. Based on the received downlink beam or SSB strength, the UE selects an RO or a combination of RO and preamble associated with an SSB with good signal quality to send Msg1. In this way, the network can determine, based on the RO or combination of RO and preamble corresponding to the received preamble, the SSB selected by the UE. Then the network sends Msg2 on the downlink beam corresponding to the SSB to ensure the received quality of the downlink signal.

Taking FIG. 7 as an example, if the number of FDM ROs at one moment is 8, the number of actually transmitted SSBs is 4, namely SSB #0, SSB #1, SSB #2, and SSB #3, with each SSB associated with two ROs. If the UE determines to send PRACH/Msg1 on the RO corresponding to SSB #0, the UE selects one RO from RO #0 and RO #1 to send PRACH.

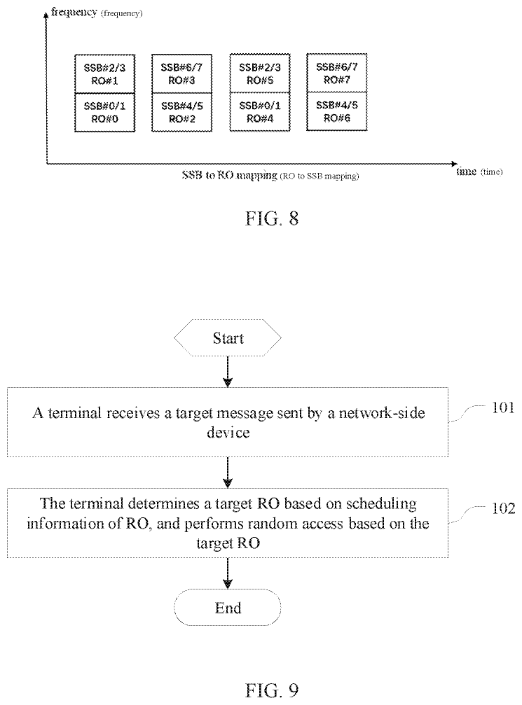

Taking FIG. 8 as an example, if the number of FDM ROs at one moment is 2, the number of actually transmitted SSBs is 8, namely SSB #0, SSB #1, . . . , SSB #7, with every two SSBs are associated with one RO. When multiple SSBs share one RO, the preamble sets associated with the multiple SSBs are different, that is, a same preamble cannot belong to preamble sets associated with different SSBs at the same time. Taking RO #0 in FIG. 8 as an example, RO #0 has a total of 60 preambles, where preambles with indexes 0 to 29 are associated with SSB #0, and preambles with indexes 30 to 59 are associated with SSB #1.

It should be noted that each square in FIG. 8 represents one RO, and the SSB marked in the square is the SSB associated with this RO.

Before the UE sends PRACH, it first selects an SSB with the RSRP higher than the threshold based on the reference signal received power (Reference Signal Received Power, RSRP) of the received beam (beam) (such as SSB). If there are multiple SSBs with the RSRP higher than the threshold, the terminal can select any one SSB with the RSRP higher than the threshold; if there is no SSB with the RSRP higher than the threshold, the UE selects one SSB based on implementation.

Based on the network (NW) configuration, the UE obtains a correspondence between SSBs and ROs. After selecting the SSB, the RO corresponding to the selected SSB is used as the RO for sending PRACH/Preamble/Msg1. If the selected SSB is associated with multiple ROs, the terminal can select one of the ROs to send PRACH/Preamble/Msg1.

For example, in the example shown in FIG. 7, assuming that the UE selects SSB #1, the UE can select one from RO #2 and RO #3 to send PRACH/Msg1; in the example shown in FIG. 8, if the UE selects SSB #1, the UE can select an available RO closest to the current time from the ROs associated with SSB #1 (such as RO #0 or RO #4) to send PRACH/Msg1. In the selected RO, the UE selects one preamble from the preamble set associated with the selected SSB to send PRACH. As shown in FIG. 8, if one RO is associated with two SSBs, then within the available preamble set associated with the SSBs in that RO, the preambles are divided into two subsets, with each subset corresponding to one SSB. The UE selects a preamble sequence from the preamble subset corresponding to the selected SSB to send PRACH/Msg1.

The following describes in detail a random access method and apparatus, a terminal, and a network-side device according to the embodiments of this application with reference to the accompanying drawings through some embodiments and application scenarios thereof.

Referring to FIG. 9, FIG. 9 is a flowchart of a random access method according to an embodiment of this application. As shown in FIG. 9, the random access method includes the following steps.

Step 101: A terminal receives a target message sent by a network-side device, where the target message carries scheduling information of physical random access channel transmission occasion RO.

Step 102: The terminal determines a target RO based on the scheduling information of RO, and performs random access based on the target RO; where
the target message includes at least one of the following:
a random access response message;
a paging-related message; and
common downlink control information (Downlink Control Information, DCI).

The scheduling information of RO may include a combination of one or more of the following: first configuration information of an RO, time-domain or frequency-domain position information of an RO, repetition period information of an RO, validity duration information of an RO, first indication information, or the like. This embodiment is not limited thereto, and any information that can be used to schedule an RO can be used as the scheduling information of RO. The first indication information is used to indicate whether the RO is valid. The validity duration information may indicate the duration for which the RO is considered available.

The RO corresponding to the scheduling information of RO may be used to determine the target RO. The terminal may determine the target RO based on the RO corresponding to the scheduling information of RO, and perform random access based on the target RO.

The RO corresponding to the scheduling information of RO can be understood as a dynamic RO, and the dynamic RO can also be described as an additional RO, or a flexible RO, or a dynamic RO. The dynamic RO is different from a legacy RO (that is, an RO scheduled not through the target message), and is a newly introduced RO, that is, an RO scheduled through the target message.

The determining, by the terminal a target RO based on the scheduling information of RO, and performing random access based on the target RO may include: determining, by the terminal the target RO based on the scheduling information of RO and second configuration information carried by system information, and performing random access based on the target RO; or selecting, by the terminal, an RO from the RO corresponding to the scheduling information of RO and an RO corresponding to third configuration information carried by the system information, and performing, by the terminal random access based on the selected target RO; or selecting, by the terminal, an RO from the RO corresponding to the scheduling information of RO, and performing, by the terminal, random access based on the selected target RO; or the like. This embodiment is not limited thereto. The RO corresponding to the third configuration information may be a legacy RO, and the legacy RO may be a non-dynamic RO.

In one implementation, the terminal selects an RO from the legacy RO and the flexible RO (that is, the RO corresponding to the scheduling information of RO) for the next random access attempt; or the terminal selects an RO only from the flexible RO for the next random access attempt.

In one implementation, the random access response message may be MsgB of the 2-step RACH.

In one implementation, the random access response message may be Msg2 of the 4-step RACH.

In one implementation, additional RO, or flexible RO, or dynamic RO configuration information may be carried in the random access response message; if the random access attempt of the terminal fails and the additional RO, or flexible RO, or dynamic RO configuration information is stored, the terminal applies the additional RO, or flexible RO, or dynamic RO for the next random access attempt.

In one implementation, part of the configuration information of the flexible RO (that is, the RO corresponding to the scheduling information of RO) may be broadcast in system information, and part may be carried through the random access response message; and the terminal receiving the configuration information in the random access response message may determine flexible RO configuration in combination with the flexible RO configuration information in the system information.

In one implementation, the paging-related message may include paging scheduling signaling, a paging message, a paging indication signal, a paging wake-up signal, a low-power wake-up signal, a paging short message, or the like. Any message related to the paging procedure can be understood as a paging-related message.

In one implementation, part of the configuration information of the flexible RO (that is, the RO corresponding to the scheduling information of RO) may be broadcast in system information, and part may be carried through the paging-related message; and the terminal receiving the configuration information in the paging-related message may determine flexible RO configuration in combination with the flexible RO configuration information in the system information.

In one implementation, taking the target message being a random access response message as an example, if the terminal has not detected a matching random access response message by the end of the random access response time window, the terminal applies the dynamically scheduled RO (that is, the RO corresponding to the scheduling information of RO) for subsequent random access attempts; if the terminal has detected a matching random access response message, it proceeds with the subsequent process, for example: in the 4-step RACH procedure, the subsequent process is sending RACH Msg3; in the 2-step RACH procedure, the random access procedure ends, and the UE performs subsequent operations.

In one implementation, taking the target message being a paging-related message as an example, when the terminal receives the paging message, if the paging message indicates that the terminal is paged, the terminal uses the scheduling information of RO carried in the paging message to perform random access.

In one implementation, taking the target message being common DCI as an example, a new downlink scheduling ID X may be defined, and the network side uses downlink scheduling signaling to indicate the scheduling ID X: the scheduling signaling is used to indicate resource information of the dynamically scheduled RO (that is, the RO corresponding to the scheduling information of RO).

In one implementation, part of the configuration information of the flexible RO (that is, the RO corresponding to the scheduling information of RO) may be broadcast in system information, and part may be carried through common DCI; and the terminal receiving the configuration information in the common DCI may determine flexible RO configuration in combination with the flexible RO configuration information in the system information.

It should be noted that in a case that the target message is a random access response message, the embodiments of this application can solve the problem that the random backoff mechanism in the related art leads to increased latency for the terminal to perform the next random access attempt when congestion occurs. In the random access procedure of the related art, if congestion occurs in the RACH channel, the network side sends a backoff indicator of a maximum waiting time T; the terminal selects a duration Twait with equal probability between 0 and the maximum waiting time T based on the backoff indicator, and after waiting for the duration Twait, the terminal can initiate a next random access attempt. Because different terminals select different Twait values, the RACH congestion problem is alleviated. This random backoff mechanism results in increased latency for the terminal to perform the next random access attempt. In the embodiments of this application, the terminal monitors the random access response message (such as Msg2 or MsgB) within a time window for monitoring the random access response. If the random access response message contains scheduling information of RO of a dynamic RO, the terminal applies the RO for subsequent random access attempts. The embodiments of this application can reduce the latency for the terminal to perform random access attempts while alleviating RACH channel congestion, thereby improving user experience.

In the embodiments of this application, a terminal receives a target message sent by a network-side device, where the target message carries scheduling information of physical random access channel transmission occasion RO; and the terminal determines a target RO based on the scheduling information of RO, and performs random access based on the target RO; where the target message includes at least one of the following: a random access response message; a paging-related message; and common downlink control information (DCI). In this way, the network-side device has the scheduling information of RO carried through at least one of a random access response message, a paging-related message, and DCI. Through the scheduling information of RO, more ROs can be dynamically scheduled for the terminal to perform random access, thereby shortening the waiting time for the terminal to initiate a random access attempt.

Optionally, the scheduling information of RO includes at least one of the following:
first configuration information of an RO;
time position information of an RO;
frequency position information of an RO;
repetition period information of an RO;
validity duration information of an RO; and
first indication information, used to indicate whether an RO is valid.

The first configuration information of the RO may include at least one of the following: a correspondence between preambles and beams, a PRACH root sequence number, an RSRP threshold for beam selection, and the like.

In one implementation, a mapping relationship between ROs and downlink beam information (such as SSBs) may be determined through the first configuration information of the RO in the scheduling information of RO, and an RO for sending a preamble is determined based on a downlink beam serving the terminal or selected by the UE, and a time-frequency position of the RO may be determined by the time-frequency position information of the RO in the scheduling information of RO, or may be preconfigured or protocol predefined. The determined RO for sending the preamble is the RO corresponding to the scheduling information of RO.

In one implementation, a time-frequency position of the RO may be determined through the time position information or frequency position information of the RO in the scheduling information of RO, and an RO for sending a preamble is determined based on a mapping relationship between ROs and downlink beam information (such as SSBs), the time-frequency position of the RO, and a downlink beam serving the terminal or selected by the terminal; a mapping relationship between preambles and downlink beam information (such as SSBs) may be determined by the first configuration information of the RO in the scheduling information of RO, and the terminal determines, based on a downlink beam serving or selected by the terminal, a preamble to be sent. The determined RO for sending the preamble is the RO corresponding to the scheduling information of RO.

In one implementation, the scheduling information of RO may include the validity duration information of the RO. The determining, by the terminal, a target RO based on the scheduling information of RO, and performing random access based on the target RO may include: within a validity time corresponding to the validity duration information of the RO, determining, by the terminal, the target RO based on the scheduling information of RO, and performing random access based on the target RO.

In one implementation, the scheduling information of RO may include first indication information, and the determining, by the terminal, a target RO based on the scheduling information of RO, and performing random access based on the target RO may include: in a case that the first indication information indicates that the target RO is valid, performing, by the terminal, random access based on the target RO.

In this implementation, the terminal can determine the target RO through at least one of the first configuration information of the RO, the time or frequency position information of the RO, the repetition period information of the RO, the validity duration information of the RO, and the first indication information, and perform random access based on the target RO. This can increase the number of optional ROs available for the terminal to perform random access, reduce the probability of RACH collision, and shorten the waiting time for the terminal to initiate a random access attempt.

Optionally, the target message includes a random access response message, and the determining, by the terminal, a target RO based on the scheduling information of RO, and performing random access based on the target RO includes:
in a case that the terminal determines that random access fails, determining, by the terminal, the target RO based on the scheduling information of RO, and performing a next random access preamble transmission based on the target RO.

Random access failure may mean that the random access response reception is not successful (the Random Access Response reception not successful) and the random access procedure is not completed (the Random Access procedure is not completed). The Random Access Response reception not successful includes two cases: the random access is not completed, or the random access is completed but unsuccessful. In a case that the terminal determines that the random access response reception is not successful and the random access is not completed, the terminal may continue to initiate the next random access preamble transmission (for example, in a case that the maximum number of RACH attempts is not reached).

In this implementation, in a case that the terminal determines that random access fails, the terminal determines the target RO based on the scheduling information of RO carried in the random access response message, and performs a next random access preamble transmission based on the target RO. In this way, the network side can schedule more ROs through the random access response message for the terminal with failed random access to use for random access in a short time, avoiding introduction of a long waiting time (backoff) for another RACH attempt.

Optionally, after the receiving, by a terminal, a target message sent by a network-side device, the method further includes:
storing, by the terminal, the scheduling information of RO; and
the determining, by the terminal in a case that the terminal determines that random access fails, a target RO based on the scheduling information of RO, and performing a next random access preamble transmission based on the target RO includes:
in a case that the terminal determines that random access fails, if the terminal stores the scheduling information of RO, determining, by the terminal, the target RO based on the stored scheduling information of RO, and performing a next random access preamble transmission based on the target RO.

The terminal stores the scheduling information of RO, for example, stores all or part of the parameters carried by the scheduling information of RO.

The terminal may determine a random access response time window and receive the random access response message within the random access response time window. If the received random access response message includes scheduling information of RO, the terminal stores the scheduling information of RO.

In addition, if by the end of the random access response time window, the terminal has not detected a random access response message including a preamble identifier matching a preamble identifier sent by the terminal, the terminal determines the target RO based on the stored scheduling information of RO, and performs a next random access preamble transmission based on the target RO.

In one implementation, if within the random access response time window, the terminal receives a random access response message including no scheduling information of RO, the terminal clears the stored scheduling information of RO.

In one implementation, when the scheduling information of RO includes validity duration information, the terminal starts timing upon receiving of the scheduling information of RO; after a validity time corresponding to the validity duration information has elapsed, the terminal may delete the stored scheduling information of RO; and if the terminal receives new scheduling information of RO during the timing period, it restarts timing based on the new validity duration information.

In one implementation, after the terminal successfully completes random access (for example, successfully receives Msg4 of the 4-step RACH procedure), the terminal clears or releases a random access resource dynamically scheduled by the network side, such as clearing the stored scheduling information of RO.

In this implementation, in a case that the terminal determines that random access fails, if the terminal stores scheduling information of RO, the terminal determines the target RO based on the stored scheduling information of RO, and performs a next random access preamble transmission based on the target RO. In this way, by storing the scheduling information of RO, the terminal can determine, when needing to perform a random access attempt, the target RO through the stored scheduling information of RO and send the random access preamble, enabling the terminal with failed random access to perform the random access attempt in a short time.

Optionally, that the terminal determines that random access fails includes at least one of the following:
if the terminal does not detect, in a random access response message corresponding to a random access response time window, a random access response message including a preamble identifier matching a preamble identifier sent by the terminal, determining, by the terminal, that random access fails; and
if contention resolution of the terminal is unsuccessful, determining, by the terminal, that random access fails.

The random access response time window may refer to ra-ResponseWindow configured in RACH-ConfigCommon (ra-ResponseWindow configured in RACH-ConfigCommon). Not detecting a random access response message including a preamble identifier matching a preamble identifier (Preamble_INDEX) sent by the terminal may be understood as that the random access response containing random access preamble identifiers that matches the transmitted PREAMBLE_INDEX has not been received (the Random Access Response containing Random Access Preamble identifiers that matches the transmitted PREAMBLE_INDEX has not been received).

Optionally, the method further includes:
receiving, by the terminal, system information, where the system information carries second configuration information of the target RO; and
the determining, by the terminal, a target RO based on the scheduling information of RO, and performing random access based on the target RO includes:
determining, by the terminal, the target RO based on the scheduling information of RO and the second configuration information, and performing random access based on the target RO.

The second configuration information of the target RO may include at least one of the following: a correspondence between preambles and beams, a PRACH root sequence number, an RSRP threshold for beam selection, and the like.

It should be noted that the terminal may obtain part of the configuration of the target RO through cell-broadcast system information, and use it in combination with the scheduling information of RO included in the target message to determine the time-frequency position of the target RO, the parameter for generating the preamble sequence, and the like.

In this implementation, the terminal determines the target RO based on the scheduling information of RO and the second configuration information, and performs random access based on the target RO. In this way, part of the configuration of the target RO can be carried through system information, thereby reducing the complexity of the scheduling information of RO. The target RO is indicated by using the scheduling information of RO with fewer bits in conjunction with the system information, thereby reducing signaling overheads.

Optionally, the determining, by the terminal, a target RO based on the scheduling information of RO, and performing random access based on the target RO includes:
selecting, by the terminal, an RO from the RO corresponding to the scheduling information of RO and an RO corresponding to third configuration information carried by the system information; and
performing, by the terminal, random access based on the selected target RO.

The RO corresponding to the third configuration information carried by the system information may be an RO configured by the third configuration information carried by the system information. The RO corresponding to the third configuration information may also be described as a non-dynamic RO configured by the system information, or a non-dynamic RO broadcast in the system information.

In one implementation, within a validity time corresponding to the validity duration information of the RO in the scheduling information of RO, the terminal selects an RO from the RO corresponding to the scheduling information of RO and an RO corresponding to the third configuration information carried by the system information; and the terminal performs random access based on the selected target RO.

It should be noted that the RO corresponding to the third configuration information carried by the system information can be understood as a non-dynamic RO. Within a validity time corresponding to the validity duration information of the RO, the terminal considers that both the non-dynamic RO broadcast in the system information and the dynamic RO scheduled by the target message can be used for the random access procedure.

In this implementation, the terminal selects an RO from the RO corresponding to the scheduling information of RO and the RO corresponding to the third configuration information carried by the system information; and the terminal performs random access based on the selected target RO. In this way, an RO is selected from the RO corresponding to the scheduling information of RO and the RO corresponding to the third configuration information carried by the system information for random access, so that more ROs can be dynamically scheduled for the terminal to perform random access, thereby shortening the waiting time for the terminal to initiate a random access attempt.

Optionally, the selected RO is a next (next) RO closest to current time among the RO corresponding to the scheduling information of RO and the RO corresponding to the third configuration information.

The current time may be the time when the RO selection is performed.

In this implementation, when the terminal performs a new round of random access resource selection, the terminal selects the temporally nearest RO for random access; regardless of whether it is a non-dynamic RO broadcast by the system information or a dynamic RO scheduled by the target message.

Optionally, the determining, by the terminal, a target RO based on the scheduling information of RO, and performing random access based on the target RO includes:
selecting, by the terminal, an RO from the RO corresponding to the scheduling information of RO; and
performing, by the terminal, random access based on the selected target RO.

It should be noted that the terminal receiving the scheduling information of RO may consider that the non-dynamic RO broadcast in the system information is invalid or not available (not available), meaning that only the RO scheduled by the target message can be used for the random access procedure.

In this implementation, the terminal selects an RO from the RO corresponding to the scheduling information of RO; and the terminal performs random access based on the selected target RO. In this way, a terminal receiving the scheduling information of RO and a terminal not receiving the scheduling information of RO use different RO resources for random access, reducing the random access load on non-dynamic RO resources.

Optionally, the selecting, by the terminal, an RO from the RO corresponding to the scheduling information of RO includes:
within a validity time corresponding to the validity duration information of the RO corresponding to the scheduling information of RO, selecting, by the terminal, an RO from the RO corresponding to the scheduling information of RO.

In one implementation, within a validity time corresponding to the validity duration information of the RO corresponding to the scheduling information of RO, the terminal selects an RO only from the RO corresponding to the scheduling information of RO.

In this implementation, within the validity time corresponding to the validity duration information of the RO, the terminal receiving the scheduling information of RO may consider that the non-dynamic RO broadcast in the system information is invalid, meaning that only the RO scheduled by the target message can be used for the random access procedure.

Optionally, the target message includes a target media access control MAC subheader or a target MAC control element (Control Element, CE), where the target MAC subheader or the target MAC CE carries the scheduling information of RO.

It should be noted that the target MAC subheader or the target MAC CE may be a newly introduced MAC subheader or MAC CE; or may be a MAC subheader or MAC CE obtained by enhancing or extending an existing MAC subheader or MAC CE.

Optionally, the target MAC subheader or the target MAC CE carries second indication information, where the second indication information is used to indicate a type of the target MAC subheader or the target MAC CE.

The terminal may determine, through the second indication information, whether the received MAC subheader or MAC CE is the target MAC subheader or target MAC CE carrying the scheduling information of RO.

In this implementation, the target MAC subheader or the target MAC CE carries second indication information, where the second indication information is used to indicate a type of the target MAC subheader or target MAC CE, so that the terminal can quickly determine, through the second indication information, the MAC subheader or MAC CE carrying the scheduling information of RO.

Optionally, the scheduling information of RO includes third indication information, where the third indication information is used to indicate at least one valid RO from the RO corresponding to the third configuration information carried by the system information.

The target RO may be a valid RO from an RO corresponding to the third configuration information carried by the system information indicated by the third indication information.

The RO corresponding to the third configuration information carried by the system information may be an RO configured by the third configuration information carried by the system information. The RO corresponding to the third configuration information may also be described as a non-dynamic RO configured by the system information, or a non-dynamic RO broadcast in the system information.

In one implementation, the third indication information may be a dynamic RO configuration field, used to provide configuration of the dynamic RO. The third indication information may be associated with the RO configuration provided in the system information. For example, the system information carries N sets of dynamic RO configurations (N>=1), and the third indication information indicates an index of a currently valid configuration, and the valid configuration indicated by the third indication information is configuration of the target RO.

In one implementation, the third indication information indicates enabling or disabling the RO configured by the third configuration information carried by the system information. For example, 1-bit third indication information is used to indicate enabling or disabling the RO configured by the third configuration information; or multi-bit third indication information is used to indicate a proportion of ROs configured by the third configuration information to be enabled, such as enabling 0%, 50%, 25%, 75%, or 100% of the ROs configured by the third configuration information.

In one implementation, the third indication information may further indicate validity duration information of the target RO.

It should be noted that the third indication information may be composed of multiple parts, used to carry different information. For example, the third indication information may be further used to indicate time or frequency resource configuration of the target RO, a configuration index of the time or frequency resource configuration, validity duration configuration, or the like.

In this implementation, the scheduling information of RO includes third indication information, where the third indication information is used to indicate at least one valid RO from the RO corresponding to the third configuration information carried by the system information, so that the target RO can be indicated using the scheduling information of RO with fewer bits in conjunction with the system information, reducing signaling overheads.

Optionally, the paging-related message includes at least one of the following:
paging scheduling signaling; a paging message; a paging indication signal; a paging wake-up signal; a low-power wake-up signal; and a paging short message.

Optionally, the RO corresponding to the scheduling information of RO and the RO corresponding to the third configuration information carried by the system information are separately mapped to synchronization signal blocks (SSBs).

It should be noted that the RO corresponding to the third configuration information carried by the system information and the dynamically scheduled RO are separately mapped to the SSB. If the network side sends the scheduling information of RO, the dynamically scheduled target RO does not change a mapping relationship between the RO corresponding to the third configuration information carried by the system information and the SSB. The RO corresponding to the third configuration information carried by the system information can be understood as a legacy (legacy) RO.

In this implementation, the RO corresponding to the scheduling information of RO and the RO corresponding to the third configuration information carried by the system information are separately mapped to synchronization signal blocks (SSBs). In this way, regardless of whether the network side sends the scheduling information of RO, a mapping relationship between the RO corresponding to the third configuration information carried by the system information and the SSB does not change, avoiding the situation that the network side cannot uniquely determine the SSB based on the preamble sent on the RO by the terminal.

Optionally, the target message includes common DCI, the common DCI carries scheduling information of RO, and the scheduling information of RO includes a scheduling identifier; and the determining, by the terminal, a target RO based on the scheduling information of RO, and performing random access based on the target RO includes:
determining, by the terminal, a target RO based on an RO corresponding to the scheduling identifier, and performing random access based on the target RO.

The RO corresponding to the scheduling identifier may include one or more ROs, and the terminal may select an RO from the ROs corresponding to the scheduling identifier and perform random access based on the selected target RO. For example, the target RO may be a next RO closest to current time among the ROs corresponding to the scheduling identifier.

In one implementation, a scheduling identifier (such as scheduling ID X) may be agreed upon by a protocol for RO scheduling. When the network sends common DCI, and the common DCI indicates that the scheduled ID is X, the terminal receiving the common DCI determines the target RO based on the indication in the common DCI.

In this implementation, the terminal performs random access based on the RO corresponding to the scheduling identifier carried by the common DCI, so that the network side can schedule more ROs through the common DCI for the terminal with failed random access to use for random access in a short time, avoiding introduction of a long waiting time for the next RACH attempt.

Optionally, the determining, by the terminal, a target RO based on the scheduling information of RO, and performing random access based on the target RO includes:
in a case of determining that the terminal is a target-type terminal, determining, by the terminal, the target RO based on the scheduling information of RO, and performing random access based on the target RO; where
the terminal determines whether the terminal is a target-type terminal based on at least one of the following:
the number of random access attempts of the terminal; a preamble transmission power of the terminal; a received signal strength indication (Received Signal Strength Indication, RSSI) of a serving cell measured by the terminal; a reference signal received quality (Reference Signal Received Quality, RSRQ) of a serving cell measured by the terminal; a radio resource control (RRC) state of the terminal; a capability or a type of the terminal; and a service trigger type for which the terminal performs random access.

The target-type terminal may be a terminal with specific characteristics.

In one implementation, the target-type terminal may include at least one of the following:
a terminal whose number of RACH attempts is below a specified threshold;
a terminal whose number of RACH attempts is equal to or above a specified threshold;
a terminal whose preamble transmission power is below a specified threshold;
a terminal whose preamble transmission power is equal to or above a specified threshold;
a terminal whose measured RSSI/RSRQ of a serving cell (serving cell) is below a specified threshold;
a terminal whose measured RSSI/RSRQ of a serving cell is equal to or above a specified threshold;
a terminal in a specific RRC state, such as an idle (idle) state, inactive (inactive) state, or connected (connected) state terminal;
a terminal supporting a specific capability, such as a terminal supporting access to satellites (such as a non-terrestrial network (Non-Terrestrial Network, NTN)), or a terminal supporting a reduced capability (RedCap) feature; and
a terminal whose RACH is triggered by a specific service type, such as data or signaling.

In this implementation, in a case of determining that the terminal is a target-type terminal, the terminal determines a target RO based on the scheduling information of RO, and performs random access based on the target RO. In this way, only the target-type terminal is allowed to determine the target RO based on the scheduling information of RO and perform random access based on the target RO. This provides more ROs for the target-type terminal to perform random access, thereby shortening the waiting time for the target-type terminal to initiate a random access attempt.

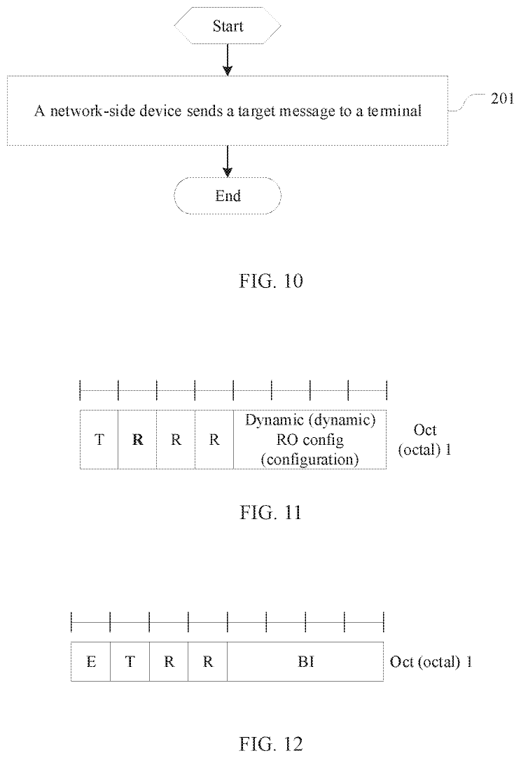

Referring to FIG. 10, FIG. 10 is a flowchart of a random access method according to an embodiment of this application. As shown in FIG. 10, the random access method includes the following steps.

Step 201: A network-side device sends a target message to a terminal, where the target message carries scheduling information of physical random access channel transmission occasion RO; and the scheduling information of RO is used for random access; where
the target message includes at least one of the following:
a random access response message;
a paging-related message; and
common DCI.

The scheduling information of RO is used to determine a target RO, and the target RO is used for random access of the terminal.

It should be noted that this embodiment serves as an implementation of the network-side device corresponding to the embodiment shown in FIG. 9, and for its specific implementation, reference may be made to the relevant description of the embodiment shown in FIG. 9. To avoid repetition, details are not repeated in this embodiment.

The following describes the random access method according to the embodiments of this application through several specific embodiments.

In the following embodiments, the scheduling information of the dynamic RO may also be described as scheduling information of RO.

### Embodiment 1

In this embodiment, the random access method includes the following procedure.
(11) A UE sends a selected preamble on a selected RO.
(12) The UE determines a random access response time window based on a time-frequency position of the RO used in step (11); and receives a random access response message within the random access response time window. If a received RAR response message includes scheduling information of a dynamic RO, the UE saves the scheduling information of the dynamic RO.

Optionally, the scheduling information of the dynamic RO includes:
time-frequency position information of the dynamic RO, indication information on whether the dynamic RO is available, or the like;
configuration information of the RO, such as a correspondence between preambles and beams, a PRACH root sequence index, and an RSRP threshold for beam selection; and
available duration information, repetition period information, or the like of the dynamic RO.

Optionally, if the received RAR response message does not include the scheduling information of the dynamic RO, the UE clears the stored scheduling information of the dynamic RO.
(13) If by the end of the random access response time window, the UE does not detect a response message matching the sent preamble, the UE applies the scheduling information of the dynamic RO for subsequent random access attempts.

Optionally, the UE obtains part of configuration of the dynamic RO through a cell broadcast message, and combines it with the scheduling information of the dynamic RO included in the random access response message to determine a time-frequency position of an available dynamic RO, a parameter for generating a preamble sequence, and the like.

### Embodiment 2

In this embodiment, the random access method includes the following procedure.
Step (21). Same as step (11) in Embodiment 1.
Step (22). Same as step (12) in Embodiment 1.
Step (23). If the UE successfully receives Msg2 and sends Msg3, but fails to receive Msg4 (that is, contention resolution is unsuccessful); and if the UE has stored the scheduling information of the dynamic RO, the UE applies the scheduling information of the dynamic RO for subsequent random access attempts.

### Embodiment 3

In this embodiment, the UE applies the scheduling information of the dynamic RO for subsequent random access attempts. That the UE applies the scheduling information of the dynamic RO for subsequent random access attempts includes: within a validity time of the scheduling information of the dynamic RO, the UE considers that both a non-dynamic RO broadcast in system information and a dynamic RO scheduled by Msg2 can be used for the random access procedure.

When the UE performs a new round of random access resource selection, the UE selects the temporally nearest RO for random access, regardless of whether it is a non-dynamic RO or a dynamic RO scheduled by Msg2.

### Embodiment 4

In this embodiment, the UE applies the scheduling information of the dynamic RO for subsequent random access attempts. That the UE applies the scheduling information of the dynamic RO for subsequent random access attempts includes: within a validity time of the scheduling information of the dynamic RO, the UE that has received the scheduling information of the dynamic RO considers that a non-dynamic RO broadcast in system information is invalid, that is, only the dynamic RO scheduled by Msg2 can be used for the random access procedure.

In this way, the terminal that has received the scheduling information of the dynamic RO and the terminal that has not received the scheduling information of the dynamic RO use different RO resources for random access. This reduces the random access load on non-dynamic RO resources.

### Embodiment 5

In this embodiment, the UE applies the scheduling information of the dynamic RO for subsequent random access attempts, where the scheduling information of the dynamic RO is carried by a MAC subheader or a MAC CE. FIG. 11 shows an implementation of a MAC subheader carrying the scheduling information of the dynamic RO.

The MAC subheader contains an indication field T, indicating that the MAC subheader carries the scheduling information of the dynamic RO.

The MAC subheader carries a dynamic RO configuration field, used to provide configuration of the dynamic RO. This configuration may be associated with the configuration provided in the system information. For example, the system information carries N sets of dynamic RO configurations (N>=1), and the dynamic RO configuration field indicates an index of a currently valid configuration; and the dynamic RO configuration field may further carry a validity duration of the dynamic RO configuration.

It should be noted that the dynamic RO configuration field may be composed of multiple parts, used to carry different information, such as all or some information of time-frequency resource configuration, a configuration index, or validity duration configuration.

When the dynamic RO configuration field carries the validity duration configuration, the UE starts timing upon receiving the configuration; after the validity time has elapsed, the UE deletes the stored dynamic RO configuration; if the UE has received a new dynamic RO configuration during the timing period, it restarts timing based on the new validity duration configuration.

That the UE applies the scheduling information of the dynamic RO for subsequent random access attempts further includes: after the UE successfully completes random access (for example, successfully receives Msg4 of the 4-step RACH procedure), the UE clears or releases a random access resource dynamically scheduled by the network side, for example, clears the scheduling information of the dynamic RO stored by the UE in step (12) of Embodiment 1.

### Embodiment 6

In this embodiment, the UE applies the scheduling information of the dynamic RO for subsequent random access attempts, where the scheduling information of the dynamic RO is carried by a MAC subheader or a MAC CE.

The dynamic RO configuration field may be carried using the R bit in the existing MAC subheader, for example, the R bit in the MAC subheader of BI.

For example, one R bit indicates enabling or disabling the dynamic RO (such as flexible RO) configured in the system information; or multiple R bits indicate a proportion of enabled ROs, for example, enabling 0%, 50%, 25%, 75%, 100% of the flexible ROs configured in the system information.

FIG. 12 shows an implementation of a MAC subheader carrying the scheduling information of the dynamic RO.

### Embodiment 7

In this embodiment, a legacy (legacy) RO and a dynamically scheduled RO are separately mapped to SSBs. If the network side dynamically schedules an RO (for example, activates a flexible RO), the dynamically scheduled RO does not change a mapping relationship between legacy ROs and SSBs.

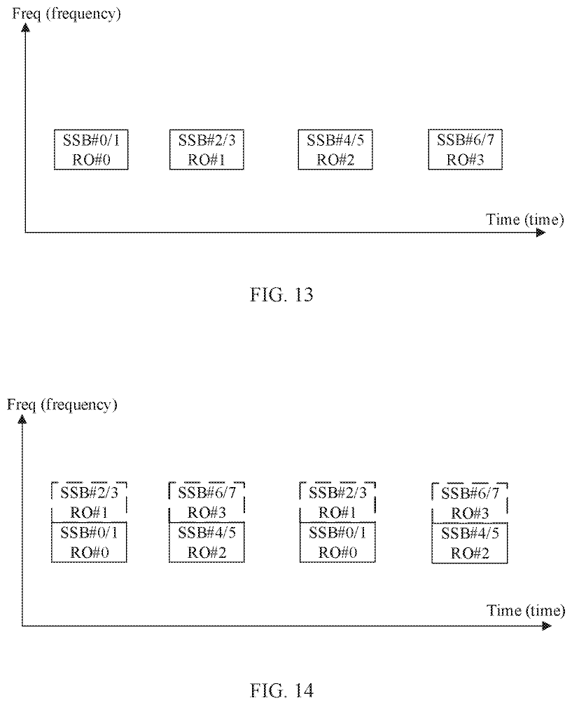

For example, FIG. 13 shows the mapping relationship between legacy ROs and SSBs. If the legacy RO and the dynamically scheduled RO are not separately mapped to the SSB, as shown in FIG. 14, the mapping relationship between legacy ROs and SSBs changes. The ROs within the dashed boxes are dynamic ROs.

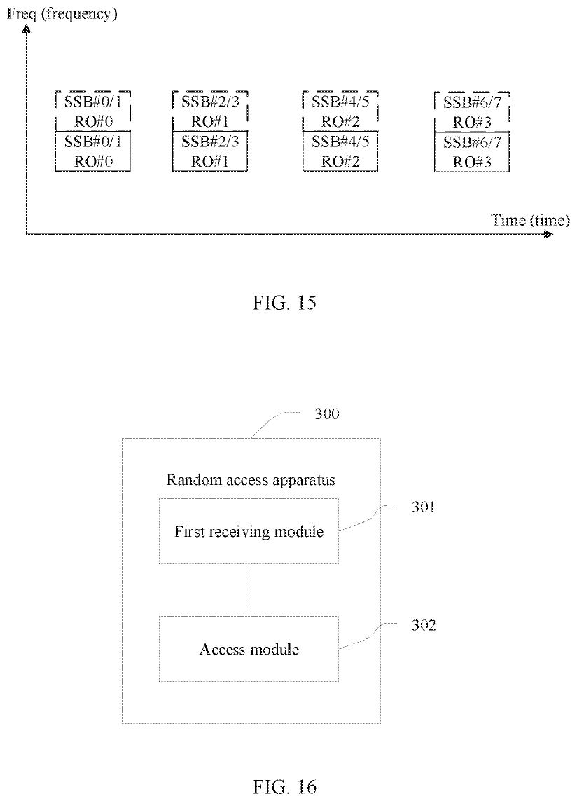

Since UE1 that has not received Msg2 does not know whether the network side has dynamically scheduled the RO, when UE1 is under the coverage of SSB #2, it selects RO1 according to FIG. 13 to send a preamble corresponding to SSB #2. In contrast, UE2 that has received Msg2 knows that the network side has dynamically scheduled the RO. Assuming that UE2 can use a legacy RO or a dynamically scheduled RO, when UE2 is under the coverage of SSB #4, it selects RO1 according to FIG. 14 to send a preamble corresponding to SSB #4. When the network side receives a preamble from RO1, it cannot determine whether the received preamble corresponds to SSB #2 or SSB #4. Therefore, the legacy RO and the dynamically scheduled RO are separately mapped to SSBs, that is, regardless of whether the network side has scheduled a dynamic RO, a mapping relationship between legacy ROs and SSBs remains unchanged. In this way, the network side can uniquely determine the SSB corresponding to the UE based on the received Msg1. For example, a mapping relationship between legacy ROs and SSBs and a mapping relationship between dynamically scheduled ROs and SSBs are shown in FIG. 15.

In other words, the mapping relationship between legacy ROs and SSBs and the mapping relationship between dynamically scheduled ROs and SSBs are independent of each other. When the UE determines the mapping relationship between legacy ROs and SSBs, it assumes that no dynamically scheduled RO is configured or scheduled; similarly, when the UE determines the mapping relationship between dynamically scheduled ROs and SSBs, it assumes that no legacy RO is configured.

### Embodiment 8

In this embodiment, in addition to be carried in the random access response message, the configuration information of the dynamic RO may also be notified to the UE during a paging procedure. A signaling or message carrying the configuration information of the dynamic RO includes but is not limited to: paging scheduling signaling (paging DCI) or a paging message (paging message), paging early indication (paging early indication, PEI), a paging wake-up signal (wake-up signal), a low-power wake-up signal (Low-power wake-up signal), a paging short message (short message), or the like. Since the paged terminal needs to initiate a RACH procedure to access the network, if the UE finds, by parsing one of the above paging-related signaling, that the configuration information of the dynamic RO in the paging-related signaling indicates that the dynamic RO is scheduled, the UE can use the dynamic RO for random access.

In addition, the ULE may periodically monitor paging messages to determine whether it is being paged. If the paging message itself or the paging scheduling signaling corresponding to the paging message indicates that a dynamic RO is scheduled, even if the UE itself is not being paged, it may record the configuration information of the dynamic RO and, upon initiating the next paging, use the dynamic RO to initiate paging. If the paging message itself or the paging scheduling signaling corresponding to the paging message does not indicate that a dynamic RO is scheduled, the UE deletes the stored configuration information of the dynamic RO. Optionally, the configuration information of the dynamic RO stored by the UE is valid within a certain time. If a validity period of the configuration information of the dynamic RO expires, the UE deletes the stored configuration information of the dynamic RO.

### Embodiment 9

In this embodiment, in addition to be carried in the random access response message, the scheduling information of the dynamic RO may also be carried in common (common) DCI. For example, a protocol specifies a scheduling ID X for scheduling the dynamic RO. When the network sends scheduling signaling (such as DCI), and the scheduling signaling indicates that the scheduled ID is X, the UE having received the scheduling signaling determines based on the indication in the scheduling signaling, an RO dynamically scheduled by the network side.

### Embodiment 10

In this embodiment, the dynamically scheduled RO may only apply to UEs with specific characteristics. For example, the UE with specific characteristics may include at least one of the following:
a UE whose number of RACH attempts is below, equal to, or above a specified threshold;
a UE whose preamble transmission power is below, equal to, or above a specified threshold;
a UE whose measured RSSI/RSRQ of a serving cell (serving cell) is below, equal to, or above a specified threshold;
a UE in a specific RRC state, such as an idle (idle) state, inactive (inactive) state, or a connected (connected) state UE;
a UE supporting a specific capability, such as a UE supporting access to satellites (such as a non-terrestrial network (Non-Terrestrial Network, NTN)), or a UE supporting a reduced capability (RedCap) feature; and
a UE whose RACH is triggered by a specific service type, such as data or signaling.

It should be noted that the configuration information for which type of terminals a dynamically scheduled RO is applicable to may be configured by the network side to the terminal through system information; or notified to the terminal through dynamic scheduling signaling, where the dynamic scheduling signaling includes at least one of the following: Msg2, MsgB, a paging (paging) message, and DCI for ID X.

In the related art, when congestion occurs in random access channel transmission, the network side configures a relatively long backoff time to discretize the time at which the terminal initiates random access again, reducing the RACH load. However, this introduces a long waiting time for the next RACH attempt, affecting user experience. In the embodiments of this application, when congestion occurs in random access channel transmission, the network side dynamically schedules more random access occasions (that is, ROs) through the random access response message (such as Msg2 or Msg B) for a terminal with unsuccessful or failed random access to use for random access in a short time, avoiding introduction of a long waiting time for the next RACH attempt.

In the embodiments of this application, on-demand scheduling is supported by having dynamic random access occasion related information carried through Msg2 or Msg B, meaning that the scheduling information is sent only when the network side detects RACH congestion. This can ensure that the dynamic random access occasion related information is received only by the terminal that needs to perform random access reattempt, avoiding interference to other terminals that do not need to acquire such information.

The random access method according to the embodiments of this application may be executed by a random access apparatus. In the embodiments of this application, a random access apparatus executing the random access method is taken as an example to describe a random access apparatus according to an embodiment of this application.

Referring to FIG. 16, FIG. 16 is a structural diagram of a random access apparatus according to an embodiment of this application, where a terminal includes the random access apparatus. As shown in FIG. 16, the random access apparatus 300 includes:
a first receiving module 301 configured to receive a target message sent by a network-side device, where the target message carries scheduling information of physical random access channel transmission occasion RO; and
an access module 302 configured to determine a target RO based on the scheduling information of RO, and perform random access based on the target RO; where
the target message includes at least one of the following:
a random access response message;
a paging-related message; and
common downlink control information (DCI).

Optionally, the scheduling information of RO includes at least one of the following:
first configuration information of an RO;
time position information of an RO;
frequency position information of an RO;
repetition period information of an RO;
validity duration information of an RO; and
first indication information, used to indicate whether an RO is valid.

Optionally, the target message includes a random access response message, and the access module 302 is specifically configured to:
in a case that the terminal determines that random access fails, determine, for the terminal, the target RO based on the scheduling information of RO, and perform a next random access preamble transmission based on the target RO.

Optionally, the apparatus further includes:
a storage module configured to store the scheduling information of RO; and
the access module 302 is specifically configured to:
in a case that the terminal determines that random access fails, if the terminal stores the scheduling information of RO, determine the target RO based on the stored scheduling information of RO, and perform a next random access preamble transmission based on the target RO.

Optionally, that the terminal determines that random access fails includes at least one of the following:
if the terminal does not detect, in a random access response message corresponding to a random access response time window, a random access response message including a preamble identifier matching a preamble identifier sent by the terminal, determining, by the terminal, that random access fails; and
if contention resolution of the terminal is unsuccessful, determining, by the terminal, that random access fails.

Optionally, the apparatus further includes:
a second receiving module configured to receive system information, where the system information carries second configuration information of the target RO; and
the access module 302 is specifically configured to:
determine the target RO based on the scheduling information of RO and the second configuration information, and perform random access based on the target RO.

Optionally, the access module 302 is specifically configured to:
select an RO from the RO corresponding to the scheduling information of RO and an RO corresponding to third configuration information carried by the system information;
perform random access based on the selected target RO.

Optionally, the target RO is a next RO closest to current time among the RO corresponding to the scheduling information of RO and the RO corresponding to the third configuration information.

Optionally, the access module 302 is specifically configured to:
select an RO from the RO corresponding to the scheduling information of RO; and
perform random access based on the selected target RO.

Optionally, the access module 302 is specifically configured to:
within a validity time corresponding to the validity duration information of the RO corresponding to the scheduling information of RO, select an RO from the RO corresponding to the scheduling information of RO; and
perform random access based on the selected target RO.

Optionally, the target message includes a target media access control MAC subheader or a target MAC control element CE, where the target MAC subheader or the target MAC CE carries the scheduling information of RO.

Optionally, the target MAC subheader or the target MAC CE carries second indication information, where the second indication information is used to indicate a type of the target MAC subheader or the target MAC CE.

Optionally, the scheduling information of RO includes third indication information, where the third indication information is used to indicate at least one valid RO from the RO corresponding to the third configuration information carried by the system information.

Optionally, the paging-related message includes at least one of the following:
paging scheduling signaling; a paging message; a paging indication signal; a paging wake-up signal; a low-power wake-up signal; and a paging short message.

Optionally, the RO corresponding to the scheduling information of RO and the RO corresponding to the third configuration information carried by the system information are separately mapped to synchronization signal blocks (SSBs).

Optionally, the target message includes the common DCI, where the common DCI carries the scheduling information of RO, and the scheduling information of RO includes a scheduling identifier; and the access module 302 is specifically configured to:
determine a target RO based on an RO corresponding to the scheduling identifier, and perform random access based on the target RO.

Optionally, the access module 302 is specifically configured to:
in a case that it is determined that the terminal is a target-type terminal, determine the target RO based on the scheduling information of RO, and perform random access based on the target RO; where
the terminal determines whether the terminal is a target-type terminal based on at least one of the following:
the number of random access attempts of the terminal; a preamble transmission power of the terminal; a received signal strength indication (RSSI) of a serving cell measured by the terminal; a reference signal received quality (RSRQ) of a serving cell measured by the terminal; a radio resource control (RRC) state of the terminal; a capability or a type of the terminal; and a service trigger type for which the terminal performs random access.

The random access apparatus in the embodiments of this application may be an electronic device, such as an electronic device having an operating system, or a component in an electronic device, such as an integrated circuit or a chip. The electronic device may be a terminal or another device different from the terminal. For example, the terminal may include but is not limited to the types of the terminal 11 listed above, and the another device may be a server, a network attached storage (Network Attached Storage, NAS), or the like, which are not specifically limited in the embodiments of this application.

The random access apparatus according to the embodiments of this application can implement each process implemented by the method embodiment in FIG. 9, with the same technical effects achieved. To avoid repetition, details are not described herein.

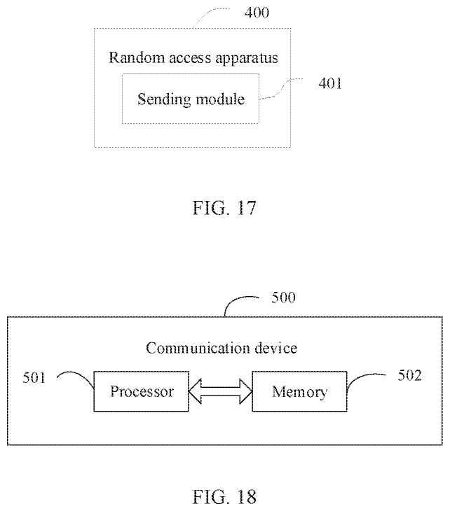

Referring to FIG. 17, FIG. 17 is a structural diagram of a random access apparatus according to an embodiment of this application, where a network-side device includes the random access apparatus. As shown in FIG. 17, the random access apparatus 400 includes:
a sending module 401 configured to send a target message to a terminal, where the target message carries scheduling information of physical random access channel transmission occasion RO; and the scheduling information of RO is used for random access;
where the target message includes at least one of the following:
a random access response message;
a paging-related message; and
common DCI.

The random access apparatus in the embodiment of this application may be an electronic device, such as an electronic device having an operating system, or a component in an electronic device, such as an integrated circuit or a chip. The electronic device may be a terminal or another device different from the terminal. For example, the terminal may include but is not limited to the types of the terminal 11 listed above, and the another device may be a server, a network attached storage (Network Attached Storage, NAS), or the like, which are not specifically limited in the embodiments of this application.

The random access apparatus according to the embodiment of this application can implement each process implemented by the method embodiment in FIG. 10, with the same technical effects achieved. To avoid repetition, details are not described herein.

Optionally, as shown in FIG. 18, an embodiment of this application further provides a communication device 500 including a processor 501 and a memory 502, where the memory 502 stores a program or instructions capable of running on the processor 501. For example, in a case that the communication device 500 is a terminal, the program or instructions, when executed by the processor 501, implement each step of the foregoing random access method embodiment applied to a terminal, with the same technical effects achieved. To avoid repetition, details are not described herein. In a case that the communication device 500 is a network-side device, the program or instructions, when executed by the processor 501, implement each step of the foregoing random access method embodiment applied to a network-side device, with the same technical effects achieved. To avoid repetition, details are not described herein.

An embodiment of this application further provides a terminal including a processor and a communication interface, where the communication interface is coupled with the processor, and the processor is configured to run a program or instructions to implement the steps of the method embodiment shown in FIG. 9. This terminal embodiment corresponds to the foregoing terminal-side method embodiment, and each implementation process and implementation of the foregoing method embodiment can be applied to this terminal embodiment, with the same technical effects achieved.

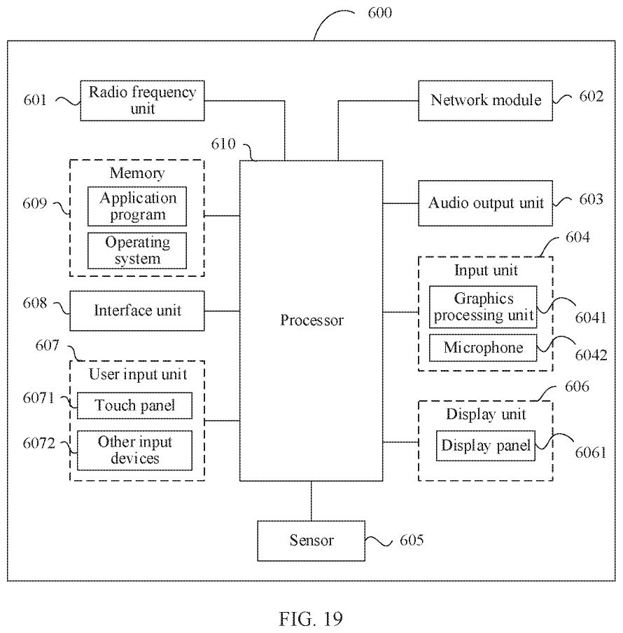

Specifically, FIG. 19 is a schematic diagram of a hardware structure of a terminal implementing an embodiment of this application.

The terminal 600 includes but is not limited to: at least some components of a radio frequency unit 601, a network module 602, an audio output unit 603, an input unit 604, a sensor 605, a display unit 606, a user input unit 607, an interface unit 608, a memory 609, a processor 610, and the like.

Those skilled in the art can understand that the terminal 600 may further include a power supply (such as a battery) supplying power to various components. The power supply may be logically connected to the processor 610 through a power management system, thereby implementing functions such as charging management, discharging management, and power consumption management through the power management system. The terminal structure shown in FIG. 19 does not constitute a limitation to the terminal. The terminal may include more or fewer components than shown in the figure, or a combination of some components, or the components disposed differently. Details are not described herein.

It should be understood that in the embodiments of this application, the input unit 604 may include a graphics processing unit (GPU) 6041 and a microphone 6042. The graphics processing unit 6041 processes image data of a still picture or video obtained by an image capture apparatus (such as a camera) in a video capture mode or an image capture mode. The display unit 606 may include a display panel 6061, and the display panel 6061 may be configured in a form of a liquid crystal display, an organic light-emitting diode, or the like. The user input unit 607 includes at least one of a touch panel 6071 and other input devices 6072. The touch panel 6071 is also referred to as a touchscreen. The touch panel 6071 may include two parts: a touch detection apparatus and a touch controller. The other input devices 6072 may include but are not limited to a physical keyboard, a function key (such as a volume control key or an on/off key), a trackball, a mouse, and a joystick. Details are not described herein.

In the embodiments of this application, after receiving downlink data from the network-side device, the radio frequency unit 601 can transmit the downlink data to the processor 610 for processing. In addition, the radio frequency unit 601 can send uplink data to the network-side device. Typically, the radio frequency unit 601 includes but is not limited to an antenna, an amplifier, a transceiver, a coupler, a low noise amplifier, and a duplexer.

The memory 609 may be configured to store a software program or instructions and various data. The memory 609 may mainly include a first storage area for storing programs or instructions and a second storage area for storing data. The first storage area may store an operating system, an application program or instructions required by at least one function (for example, a sound play function or an image play function), and the like. Additionally, the memory 609 may include a volatile memory or a non-volatile memory, or the memory 609 may include both a volatile memory and a non-volatile memory. The non-volatile memory may be a read-only memory (ROM), a programmable read-only memory (PROM), an erasable programmable read-only memory (EPROM), an electrically erasable programmable read-only memory (Electrically EPROM, EEPROM), or a flash memory. The volatile memory may be a random access memory (RAM), a static random access memory (Static RAM, SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), or a direct rambus random access memory (DRRAM). The memory 609 in the embodiment of this application includes but is not limited to these and any other suitable types of memory.

The processor 610 may include one or more processing units. Optionally, the processor 610 integrates an application processor and a modem processor. The application processor primarily processes operations involving an operating system, a user interface, an application program, or the like. The modem processor, for example, a baseband processor, primarily processes radio communication signals. It can be understood that the modem processor may alternatively be not integrated into the processor 610.

The radio frequency unit 601 is configured to: receive a target message sent by a network-side device, where the target message carries scheduling information of physical random access channel transmission occasion RO; and
the processor 610 is configured to: determine a target RO based on the scheduling information of RO, and perform random access based on the target RO; where
the target message includes at least one of the following:
a random access response message;
a paging-related message; and
common downlink control information (DCI).

Optionally, the scheduling information of RO includes at least one of the following:
first configuration information of an RO;
time position information of an RO;
frequency position information of an RO;
repetition period information of an RO;
validity duration information of an RO; and
first indication information, used to indicate whether an RO is valid.

Optionally, the target message includes a random access response message, and the processor 610 is specifically configured to:
in a case that the terminal determines that random access fails, determine the target RO based on the scheduling information of RO, and perform a next random access preamble transmission based on the target RO.

Optionally, the processor 610 is further configured to: store the scheduling information of RO; and
the processor 610 is specifically further configured to:
in a case that the terminal determines that random access fails, if the terminal stores the scheduling information of RO, determine the target RO based on the stored scheduling information of RO, and perform a next random access preamble transmission based on the target RO.

Optionally, that the terminal determines that random access fails includes at least one of the following:
if the terminal does not detect, in a random access response message corresponding to a random access response time window, a random access response message including a preamble identifier matching a preamble identifier sent by the terminal, determining that random access fails; and
if contention resolution of the terminal is unsuccessful, determining, by the terminal, that random access fails.

Optionally, the radio frequency unit 601 is further configured to: receive system information, where the system information carries second configuration information of the target RO; and
the processor 610 is specifically configured to:
determine the target RO based on the scheduling information of RO and the second configuration information, and perform random access based on the target RO.

Optionally, the processor 610 is specifically configured to:
select an RO from the RO corresponding to the scheduling information of RO and an RO corresponding to third configuration information carried by the system information; and
perform random access based on the selected target RO.

Optionally, the target RO is a next RO closest to current time among the RO corresponding to the scheduling information of RO and the RO corresponding to the third configuration information.

Optionally, the processor 610 is specifically configured to:
select an RO from the RO corresponding to the scheduling information of RO; and
perform random access based on the selected target RO.

Optionally, the processor 610 is specifically configured to:
within a validity time corresponding to the validity duration information of the RO corresponding to the scheduling information of RO, select an RO from the RO corresponding to the scheduling information of RO; and
perform random access based on the selected target RO.

Optionally, the target message includes a target media access control MAC subheader or a target MAC control element CE, where the target MAC subheader or the target MAC CE carries the scheduling information of RO.

Optionally, the target MAC subheader or the target MAC CE carries second indication information, where the second indication information is used to indicate a type of the target MAC subheader or the target MAC CE.

Optionally, the scheduling information of RO includes third indication information, where the third indication information is used to indicate at least one valid RO from the RO corresponding to the third configuration information carried by the system information.

Optionally, the paging-related message includes at least one of the following:
paging scheduling signaling; a paging message; a paging indication signal; a paging wake-up signal; a low-power wake-up signal; and a paging short message.

Optionally, the RO corresponding to the scheduling information of RO and the RO corresponding to the third configuration information carried by the system information are separately mapped to synchronization signal blocks (SSBs).

Optionally, the target message includes the common DCI, where the common DCI carries the scheduling information of RO, and the scheduling information of RO includes a scheduling identifier; and the processor 610 is specifically configured to:
determine a target RO based on an RO corresponding to the scheduling identifier, and perform random access based on the target RO.

Optionally, the processor 610 is specifically configured to:
in a case of determining that the terminal is a target-type terminal, determine the target RO based on the scheduling information of RO, and perform random access based on the target RO; where
the processor 610 determines whether the terminal is a target-type terminal based on at least one of the following:
the number of random access attempts of the terminal; a preamble transmission power of the terminal; a received signal strength indication (RSSI) of a serving cell measured by the terminal; a reference signal received quality (RSRQ) of a serving cell measured by the terminal; a radio resource control (RRC) state of the terminal; a capability or a type of the terminal; and a service trigger type for which the terminal performs random access.

It can be understood that for the implementation processes of the implementations mentioned in this embodiment, reference may be made to the relevant description of the method embodiment in FIG. 5, and the same or corresponding technical effects can be achieved. To avoid repetition, details are not described herein again.

Specifically, the terminal in the embodiments of this application further includes:
instructions or a program stored on the memory 609 and capable of running on the processor 610. The processor 610 calls the instructions or program in the memory 609 to execute the method executed by the modules shown in FIG. 16, with the same technical effects achieved. To avoid repetition, details are not described herein again.

An embodiment of this application further provides a network-side device including a processor and a communication interface, where the communication interface is coupled with the processor, and the processor is configured to run a program or instructions to implement the steps of the method embodiment shown in FIG. 10. This network-side device embodiment corresponds to the foregoing random access method embodiment applied to a network-side device, and each implementation process and implementation of the foregoing method embodiment can be applied to this network-side device embodiment, with the same technical effects achieved.

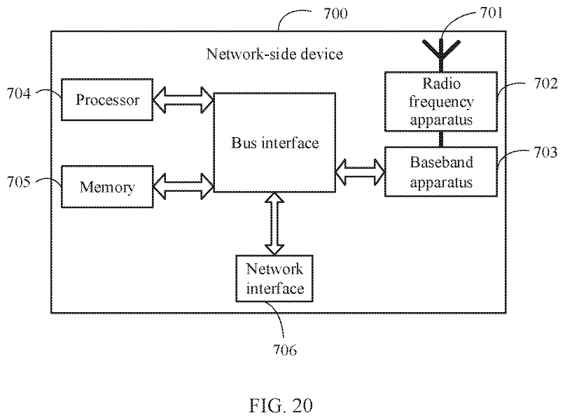

Specifically, an embodiment of this application further provides a network-side device. As shown in FIG. 20, the network-side device 700 includes: an antenna 701, a radio frequency apparatus 702, a baseband apparatus 703, a processor 704, and a memory 705. The antenna 701 is connected to the radio frequency apparatus 702. In an uplink direction, the radio frequency apparatus 702 receives information via the antenna 701, and sends the received information to the baseband apparatus 703 for processing. In a downlink direction, the baseband apparatus 703 processes to-be-sent information, and sends the information to the radio frequency apparatus 702; and the radio frequency apparatus 702 processes the received information and then sends the information out via the antenna 701.

The method executed by the network-side device in the foregoing embodiments may be implemented in the baseband apparatus 703, and the baseband apparatus 703 includes a baseband processor.

The baseband apparatus 703 may include at least one baseband board, where multiple chips are provided on the baseband board. As shown in FIG. 20, one of the chips is, for example, the baseband processor, and connected to the memory 705 via a bus interface, to invoke the program in the memory 705 to perform the operations of the network-side device shown in the foregoing method embodiments.

The network-side device may further include a network interface 706. The interface is, for example, a common public radio interface (Common Public Radio Interface, CPRI).

Specifically, the network-side device 700 in the embodiments of this application further includes: instructions or a program stored in the memory 705 and capable of running on the processor 704. The processor 704 invokes the instructions or program in the memory 705 to execute the method executed by the modules shown in FIG. 17, with the same technical effects achieved. To avoid repetition, details are not described herein again.

An embodiment of this application further provides a readable storage medium, where a program or instructions are stored on the readable storage medium, and when the program or instructions are executed by a processor, each process of the foregoing random access method embodiment is implemented, with the same technical effects achieved. To avoid repetition, details are not described herein again.

The processor is a processor in the terminal described in the foregoing embodiment. The readable storage medium includes a computer-readable storage medium, such as a computer read-only memory (ROM), a random access memory (RAM), a magnetic disk, or a compact disc. In some examples, the readable storage medium may be a non-transitory readable storage medium.

An embodiment of this application further provides a chip, where the chip includes a processor and a communication interface, the communication interface is coupled with the processor, and the processor is configured to run a program or instructions to implement each process of the foregoing random access method embodiment, with the same technical effects achieved. To avoid repetition, details are not described herein again.

It should be understood that the chip mentioned in the embodiments of this application may also be called a system-level chip, a system chip, a chip system, a system-on-chip, or the like.

An embodiment of this application further provides a computer program/program product, where the computer program/program product is stored in a storage medium, and the computer program/program product is executed by at least one processor to implement each process of the foregoing random access method embodiments, with the same technical effects achieved. To avoid repetition, details are not described herein again.

An embodiment of this application further provides a random access system including: a terminal and a network-side device, where the terminal may be configured to perform the steps of the foregoing random access method applied to a terminal, and the network-side device is configured to perform the steps of the foregoing random access method applied to a network-side device.

It should be noted that in this specification, the terms “include”, “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiments may be implemented by software with a necessary general hardware platform. Certainly, the method in the foregoing embodiments may also be implemented by hardware. The computer software product is stored in a storage medium (such as a ROM/RAM, a magnetic disk, or a compact disc), and includes several instructions for instructing a terminal or a network-side device to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A random access method, comprising:
receiving, by a terminal, a target message sent by a network-side device, wherein the target message carries scheduling information of transmission occasion (RO), wherein the RO is a physical random access channel RO; and
determining, by the terminal, a target RO based on the scheduling information of RO, and performing random access based on the target RO; wherein
the target message comprises at least one of the following:
a paging-related message; or
common downlink control information (DCI).

2. The method according to claim 1, wherein the scheduling information of the RO comprises at least one of the following:
first configuration information of the RO;
time position information of the RO;
frequency position information of the RO;
repetition period information of the RO;
validity duration information of the RO; or
first indication information, used to indicate whether the RO is valid.

3. The method according to claim 1, wherein the target message comprises a random access response message, and the determining, by the terminal, the target RO based on the scheduling information of RO, and performing random access based on the target RO comprises:
in a case that the terminal determines that random access fails, determining, by the terminal, the target RO based on the scheduling information of RO, and performing a next random access preamble transmission based on the target RO.

4. The method according to claim 3, wherein after the receiving, by the terminal, the target message sent by the network-side device, the method further comprises:
storing, by the terminal, the scheduling information of RO; and
the determining, by the terminal in a case that the terminal determines that random access fails, the target RO based on the scheduling information of RO, and performing a next random access preamble transmission based on the target RO comprises:
in a case that the terminal determines that random access fails, if the terminal stores the scheduling information of RO, determining, by the terminal, the target RO based on the stored scheduling information of RO, and performing the next random access preamble transmission based on the target RO.

5. The method according to claim 4, wherein that the terminal determines that random access fails comprises at least one of the following:
if the terminal does not detect, in a random access response message corresponding to a random access response time window, a random access response message comprising a preamble identifier matching a preamble identifier sent by the terminal, determining, by the terminal, that random access fails; or
if contention resolution of the terminal is unsuccessful, determining, by the terminal, that random access fails.

6. The method according to claim 1, wherein the method further comprises:
receiving, by the terminal, system information, wherein the system information carries second configuration information of the target RO; and
the determining, by the terminal, the target RO based on the scheduling information of RO, and performing random access based on the target RO comprises:
determining, by the terminal, the target RO based on the scheduling information of RO and the second configuration information, and performing random access based on the target RO.

7. The method according to claim 1, wherein the determining, by the terminal, the target RO based on the scheduling information of RO, and performing random access based on the target RO comprises:
selecting, by the terminal, an RO from the RO corresponding to the scheduling information of RO and at least one RO corresponding to third configuration information carried by system information; and
performing, by the terminal, random access based on the selected target RO.

8. The method according to claim 7, wherein the target RO is a next RO closest to current time among the RO corresponding to the scheduling information of RO and the RO corresponding to the third configuration information.

9. The method according to claim 1, wherein the determining, by the terminal, the target RO based on the scheduling information of RO, and performing random access based on the target RO comprises:
selecting, by the terminal, an RO from the RO corresponding to the scheduling information of RO; and
performing, by the terminal, random access based on the selected target RO.

10. The method according to claim 9, wherein the selecting, by the terminal, the RO from the RO corresponding to the scheduling information of RO comprises:
within a validity time corresponding to validity duration information of the RO corresponding to the scheduling information of RO, selecting, by the terminal, the RO from the RO corresponding to the scheduling information of RO.

11. The method according to claim 1, wherein the target message comprises a target media access control (MAC) subheader or a target MAC control element (CE), wherein the target MAC subheader or the target MAC CE carries the scheduling information of RO.

12. The method according to claim 11, wherein the target MAC subheader or the target MAC CE carries second indication information, wherein the second indication information is used to indicate a type of the target MAC subheader or the target MAC CE.

13. The method according to claim 1, wherein the scheduling information of RO comprises third indication information, wherein the third indication information is used to indicate at least one valid RO from the RO corresponding to third configuration information carried by system information.

14. The method according to claim 1, wherein the paging-related message comprises at least one of the following:
paging scheduling signaling; a paging message; a paging indication signal; a paging wake-up signal; a low-power wake-up signal; or a paging short message.

15. The method according to claim 1, wherein the RO corresponding to the scheduling information of RO and the RO corresponding to third configuration information carried by system information are separately mapped to synchronization signal blocks (SSBs).

16. The method according to claim 1, wherein the target message comprises the common DCI, the common DCI carries the scheduling information of RO, and the scheduling information of RO comprises a scheduling identifier; and the determining, by the terminal, the target RO based on the scheduling information of RO, and performing random access based on the target RO comprises:
determining, by the terminal, a target RO based on an RO corresponding to the scheduling identifier, and performing random access based on the target RO.

17. The method according to claim 1, wherein the determining, by the terminal, the target RO based on the scheduling information of RO, and performing random access based on the target RO comprises:
in a case of determining that the terminal is a target-type terminal, determining, by the terminal, the target RO based on the scheduling information of RO, and performing random access based on the target RO; wherein
the terminal determines whether the terminal is the target-type terminal based on at least one of the following:
a number of random access attempts of the terminal;
a preamble transmission power of the terminal;
a received signal strength indication (RSSI) of a serving cell measured by the terminal;
a reference signal received quality (RSRQ) of a serving cell measured by the terminal;
a radio resource control (RRC) state of the terminal;
a capability or a type of the terminal; or
a service trigger type for which the terminal performs random access.

18. A random access method, comprising:
sending, by a network-side device, a target message to a terminal, wherein the target message carries scheduling information of transmission occasion (RO), wherein the RO is a physical random access channel RO; and the scheduling information of RO is used for random access; wherein
the target message comprises at least one of the following:
a paging-related message; or
common downlink control information (DCI).

19. A network-side device, comprising a processor and a memory, wherein the memory stores a program or instructions capable of running on the processor, and the program or instructions, when executed by the processor, implement the steps of the random access method according to claim 18.

20. A terminal, comprising a processor and a memory, wherein the memory stores a program or instructions capable of running on the processor, and the program or instructions, when executed by the processor, implement the following operations:
receiving a target message sent by a network-side device, wherein the target message carries scheduling information of transmission occasion (RO), wherein the RO is a physical random access channel RO; and
determining a target RO based on the scheduling information of RO, and performing random access based on the target RO; wherein
the target message comprises at least one of the following:
a paging-related message; or
common downlink control information (DCI).
